(19) United States
(12) Patent Application Publication
(10) Pub. No.: US 2004/0176123 A1
(43) Pub. Date: Sep. 9, 2004

(54) Communicating with public safety answering points via character based messages

(76) Inventors: Frances Mu-Fen Chin, Naperville, IL (US); Daisy Feng-Mei Su, Wheaton, IL (US); ZhongJin Yang, Naperville, IL (US)

Correspondence Address: PATTI & BRILL, ONE NORTH LASALLE STREET, 44TH FLOOR, CHICAGO, IL, 60602, US

(21) Appl. No.: 10/354,312

(22) Filed: Jan. 30, 2003

(51) Int. Cl. H04M 11/00; H04B 7/00; H04Q 7/20

(52) U.S. Cl. 455/521; 455/404.1

(57) ABSTRACT

A user may transmit a character based message to invoke a request for emergency services from a public safety access point (PSAP) similar to a conventional voice call made to “911”. If the PSAP is capable of directly receiving a character based message, a user's message to a predetermined emergency address is routed to an appropriate PSAP. If the PSAP is not capable of directly receiving a character based message, the user's character based message is converted by a text-to-speech facility and transmitted over a conventional voice channel to an operator of a PSAP.

### BACKGROUND OF THE INVENTION

This invention relates to Public Safety Answering Points (PSAP) that normally receive telephone calls requesting emergency assistance such as provided by law enforcement officers, firemen, or paramedics. The invention more specifically relates to permitting users to communicate with a PSAP by the transmission of character based messages.

Public Safety Answering Points are deployed in many of the major cities of the United States and serve as the termination point for calls, e.g. “911 calls”, for emergency help requested by users. In addition to a voice communication path established between the user and a PSAP operator, the PSAP operator is typically provided with information related to the location of the user. This location information may be based on the telephone number of the calling party (user). In addition to displaying the telephone number of the user to the PSAP operator, the location of the user may be displayed on a map for easy reference by the operator in directing help to the user.

Voice communications from the user provide the operator with valuable additional information that assists the operator in determining the type of assistance to be dispatched to the user and the urgency required. Even if the user is incapacitated or not able to provide voice communications, the operator is often able to discern the type of help needed based on background sounds such as a gunshot or a burning fire. Thus, obtaining communications from the user concerning the nature of the request is important in providing the appropriate type of emergency services.

An increasing number of wireless users are coming to rely on character based messaging to at least supplement traditional voice communications. In a situation in which the user can select either traditional voice communications or character based messages, a request for emergency services can be made to a PSAP operator by the normal call to 911 with voice communications. However, situations may arise where the user may prefer to or be limited to using only character based messages, e.g. short messaging system (SMS) messages, for communications. That is, the user may be unable to speak but is able to originate character based messages. For example, a user may be unable to speak due to an injury or may be a hostage that can originate character based messages from a wireless telephone concealed from the view of the captor where it would be too dangerous to speak into the telephone. Or perhaps the user has a device, e.g. laptop computer with a wireless modem, only capable of data communications. A normal PSAP facility is equipped to receive voice calls requesting emergency services, but is not capable of directly receiving character based messages. Therefore, there exists a need for an improved communications capability that will facilitate the receipt of a request for emergency services by a PSAP facility based on a user originated character based message.

### SUMMARY OF THE INVENTION

It is an object of the present invention to provide an improved communications capability that will facilitate communications with a PSAP facility by the transmission by the user of a character based message.

In accordance with an embodiment of the present invention, a method is provided for transmitting a communication derived from a character based message from a user in a telecommunication system to a public safety answering point. A character based message addressed to a predetermined emergency address is received. A public safety answering point is identified to respond to the emergency character based message. A text-to-speech translator translates the character based message into voice communications that are transmitted to the identified public safety answering point.

In another embodiment of the present invention, a method is provided for transmitting a character based message from a user in a telecommunication system to a public safety answering point in which a character based message addressed to a predetermined emergency address is received. A public safety answering point is identified to receive the emergency character based message. If this public safety answering point is determined to be capable of receiving the emergency character based message in character based format, the emergency character based message is transmitted to the identified public safety answering point by forwarding the message to the address of the identified public safety answering point associated with the predetermined emergency address.

A further embodiment of the present invention contemplates an apparatus that supports the improved communication capabilities.

### BRIEF DESCRIPTION OF THE DRAWINGS

FIG. 1 is a block diagram illustrating a system that supports an embodiment of the present invention.

FIG. 2 is a flow diagram illustrating an exemplary method of the present invention supported by the structure of FIG. 1.

FIG. 3 is a block diagram illustrating another system that supports a further embodiment of the present invention.

FIGS. 4 and 5 are flow diagrams illustrating another exemplary method of the present invention supported by the structure of FIG. 3.

### DETAILED DESCRIPTION OF PREFERRED EMBODIMENTS

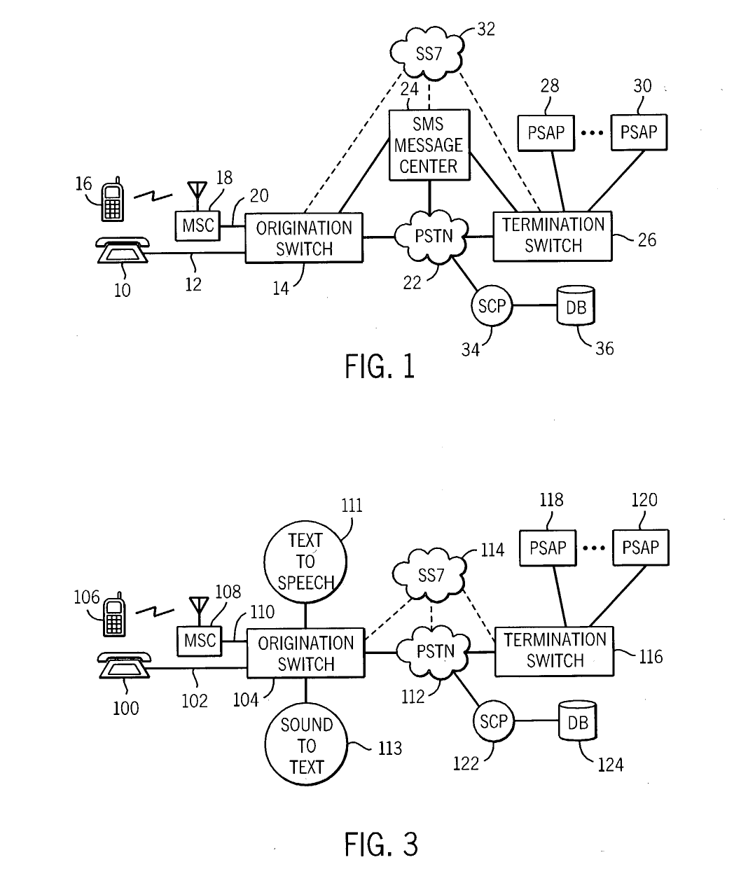

FIG. 1 illustrates a telecommunication system that incorporates an embodiment of the present invention permitting a PSAP facility to receive character based messages originated by a user as a request for emergency services. As used herein communications by “character based messages” means the conveyance of information by the transmission of symbols or text that are not direct representations of spoken words. For example, the transmission of a series of ASCII characters would be a character based message. The transmission of a series of bytes representing parts of spoken words would not constitute a character based message.

A telephone set 10 provides an associated user with conventional voice communications over communication channel 12 as supported by origination switch 14. A wireless communication device 16, such as a cellular telephone with SMS capabilities, provides an associated user with both voice and character based message communication capabilities. Communications between the wireless device 16 and origination switch 14 are provided by the mobile switching center (MSC) 18 and communication channel 20. The origination switch 14 is coupled to the public switched telephone network (PSTN) 22 that supports communication channels among a variety of telecommunication switches and nodes. The origination switch 14 is also connected to an SMS message center 24 that serves as a traffic node for receiving and routing SMS messages. A termination switch 26 is coupled to PSTN 22 and SMS message center 24, and supports PSAPs 28 and 30. These PSAPs are representative of a plurality of PSAPs that may be supported by the termination switch 26. A signaling system (SS7) network 32 supports command and control signaling among the origination switch 14, SMS message center 24 and termination switch 26, as well as other network elements in the PSTN 22. An exemplary service control point (SCP) 34 supported by a database 36 is coupled to the PSTN 22 and can be configured to provide a variety of services and functions for other nodes in the telecommunication system.

To better appreciate the contribution of the embodiments of the present invention, an example of a conventional 911 call for emergency services from a PSAP is described relative to FIG. 1. The user associated with telephone set 10 dials “911” seeking emergency help for a fire. The 911 call is identified by the origination switch 14 as an emergency call to be routed to a PSAP. In this example the origination switch 14 stores information as to which PSAP an emergency call will be routed depending on the incoming line port of the call. The origination switch 14 determines that the call will be routed to PSAP 28. Origination switch 14 utilizes SS7 network 32 to cause a call path to be set up through PSTN 22 to termination switch 26. The termination switch 26 determines the availability of PSAP 28 and establishes a call path connection between telephone set 10 and an operator at PSAP 28. The operator is provided with the calling party's telephone number by the originating party's calling line identification that is utilized by the PSAP 28 to help identify the location associated with telephone set 10. A voice conversation between the user of telephone set 10 and the operator of PSAP 28 provides the operator with information concerning the nature of the emergency request so that the operator can initiate a request for emergency services from the closest fire station to the location of the fire.

In accordance with an embodiment of the present invention a user associated with wireless telephone 16 desires to initiate a request for emergency help from a PSAP utilizing a character based message. In this example, the user is at home and believes that a burglary is in progress with a burglar being present in an adjacent room. In order to remain silent and not alert the burglar to the user's presence, the user utilizes the SMS capabilities of the wireless telephone. In this example it is assumed that a PSAP suitable for handling the emergency request has the capability of receiving and displaying character based messages to the operator. For example, the PSAP may maintain an Internet presence and have an assigned e-mail address by which a character based message can be delivered. Alternatively, the PSAP could receive character based messages by maintaining a separate wireless (cellular) access number and have an operator utilize a cellular telephone with SMS capabilities. In this case it is assumed that at least one incoming line of the PSAP is equipped to receive SMS messages.

The origination switch 14 receives by MSC 18 an SMS message from wireless device 16 with the destination address being set to the predetermined emergency service, e.g. E-911 in the United States. The receipt of an SMS message with a destination of E-911 by origination switch 14 causes it to determine if an appropriate PSAP facility with SMS message receiving capabilities exists to handle the emergency request. The origination switch 14 may maintain an internal database for locating such PSAPs or it may rely upon services such as provided by SCP 34 to determine if an appropriate PSAP exists to receive the emergency request and if so, which PSAP should receive the request. The database 36 of SCP 34 (or a database associated with origination switch 14) may contain a record associated with the PSAPs containing a field that identifies whether the PSAP is capable of receiving character based messages. The origination switch 14 determines that PSAP 28 is the appropriate PSAP to receive this request. The origination switch 14 passes the SMS message from the user and the address (as opposed to the telephone number) of PSAP 28 to SMS message center 24. The emergency SMS message is transmitted by SMS message center 24 by termination switch 26 to PSAP 28. An operator at PSAP 28 receives the incoming character based message requesting emergency help. If the received character based message contains sufficient information, the operator will initiate a request for emergency services; in this case, the operator would alert the appropriate police department of the burglary in progress at the determined location of the user of wireless telephone 16. The location of the user of a wireless telephone can be determined by various known techniques. If the initially received character based message does not contains sufficient information to permit the operator to initiate an appropriate request for emergency services, the operator may transmit a character based message to the user of wireless telephone 16 seeking any additional information needed. Upon receipt of a reply character based message from the user, the operator can then proceed to initiate an appropriate request for emergency services.

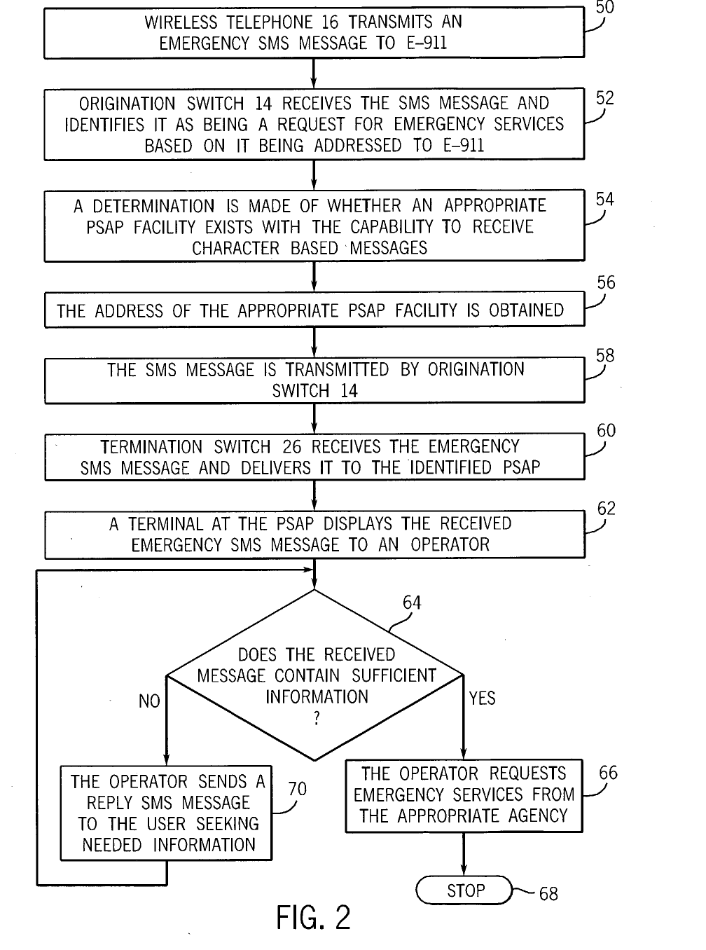

Referring to FIG. 2, in step 50 the wireless telephone 16 originates an emergency SMS message to E-911. In step 52 the origination switch 14 receives the SMS message and identifies it as being a request for emergency services based on its address, i.e. E-911. A determination is made of whether a PSAP facility exists with the capability to receive character based messages in step 54. In step 56 the address of an appropriate PSAP facility is obtained. In step 58, the origination switch 14 causes the received SMS message to be transmitted to the identified PSAP. The termination switch 26 receives the emergency SMS message and delivers it to the identified PSAP in step 60. In step 62 a terminal at the PSAP displays the received emergency SMS message to an operator. In step 64 a decision is made of whether the message contains sufficient information to permit the operator to determine the urgency and agency to respond to the emergency request. A YES determination by step 64 causes an operator to request the emergency services from the appropriate agency as indicated step 66. Having responded to the request for emergency services, the process ends at STOP step 68. A NO determination by step 64 results of the operator sending a reply SMS message to the user seeking additional information in order to respond to the request for emergency services as indicated step 70. Following step 70, the process returns to the beginning of step 64 for another determination based on a further received message from the user.

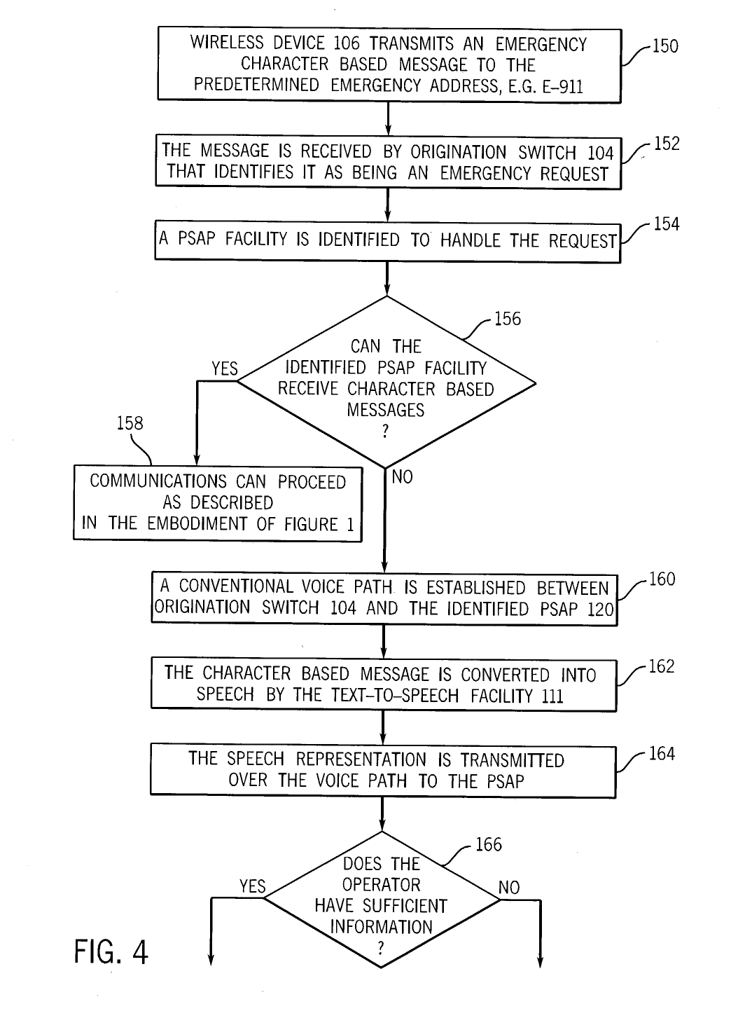

FIG. 3 illustrates a further embodiment of the present invention that supports the communication of a character based message seeking E-911 services by a user to a PSAP that does not have the direct capability of receiving character based messages. A conventional telephone set 100 is connected by a communication line 102 with the origination switch 104. A wireless communication device 106, such as but not limited to a cellular telephone with SMS message capabilities, communicates by the mobile switching center 108 and communication line 110 with the origination switch 104. Adjunct facilities 111 and 113 provide text-to-speech and sound-to-text capabilities, respectively, for origination switch 104. The adjunct facilities may comprise computer workstations that utilize known text-to-speech and sound-to-text software programs that convert character based text, e.g. ASCII characters, into speech, and convert speech into ASCII text with a known speech recognition program. Alternatively, the sound-to-text conversion may consist of the conversion of modem signaling (tones) into corresponding ASCII text depending on the format of the information to be delivered to the user. The origination switch 104 is also coupled to PSTN 112 and the SS 7 network 114. A termination switch 116 supports PSAP facilities including PSAP 118 and PSAP 120. The termination switch 116 is also connected to PSTN 112 and the SS 7 network 114. An SCP 122 is supported by database 124 and is coupled to the PSTN 112.

A brief overview of the exemplary method supported by FIG. 3 will assist in understanding the detailed explanation of the method that follows. The structure shown in FIG. 3 supports communications between a user utilizing a character based message(s) to request emergency services and a PSAP that does not have the direct capability of receiving character based messages. The origination switch 104 receives the user's character based message requesting emergency services and converts the contained text (characters) to speech with the assistance of text-to-speech facility 111. The converted speech is transmitted over a conventional voice channel to the PSAP identified to handle the request. Preferably, the operator at the PSAP is alerted at the beginning of the incoming request that the communication that follows is the result of text-to-speech conversion to help the operator in understanding the request and help the operator select the most appropriate format in which to communicate to the user if such a communication is needed. The alert may consist of a spoken message stored at the origination switch 104 such as “the following request for emergency services was received as a text message and has been converted into speech”. If the information received by the operator at the PSAP is sufficient to determine the urgency, appropriate agency to respond, and location of the user, the operator will proceed to request the appropriate emergency services. If the information is not sufficient, the operator will transmit a request for further information to the user. The operator may voice the request in which case the sound-to-text facility 113 will utilize speech recognition software to translate the speech into text characters that can be transmitted as a character based message to the user. Alternatively, the operator may elect to type a request on a connected terminal so that a modem transmits modem signals over the voice channel that are received by the sound-to-text facility 113, which converts the conventional modem signals into ASCII characters that are then transmitted as a character based message to the user. Upon receiving the character based message requesting additional information, the user will respond by transmitting another character based message that will be communicated to the operator at the selected PSAP.

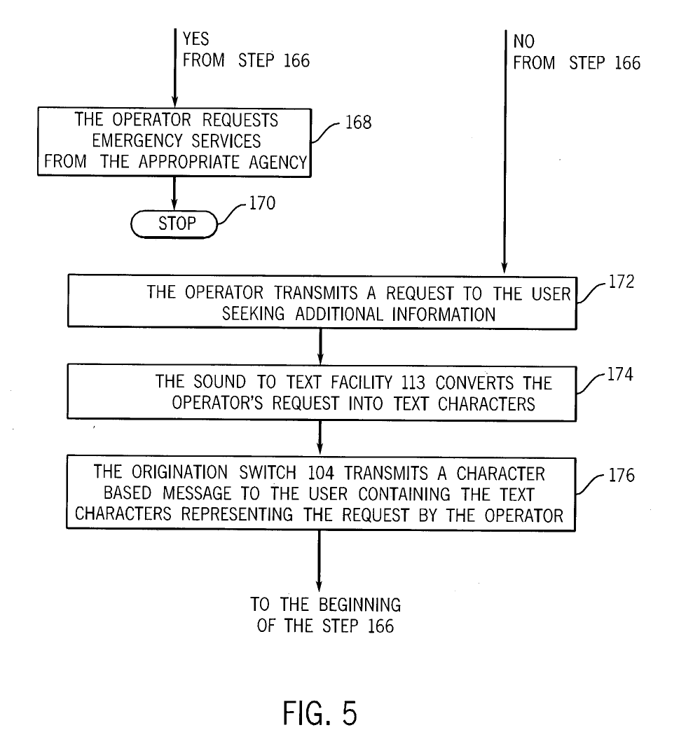

FIGS. 4 and 5 are flow diagrams illustrating an exemplary method of the present invention. Wireless device 106 transmits an emergency character based message with a predetermined emergency address, e.g. E-911, as per step 150. In step 152, the message is received by origination switch 104 that identifies it as being an emergency request based on the predetermined emergency address. A PSAP facility is identified in step 154 to handle the emergency request. The origination switch 104 may derive the identification of an appropriate PSAP facility based on information stored locally at the switch or by sending a request to SCP 122 that may store such information in records of database 124. A determination is made in step 156 of whether the identified PSAP facility can directly receive character based messages. Preferably, the record associated with the PSAP identified to handle the emergency request will contain a field that indicates whether the PSAP can directly receive character based messages. A YES determination by step 156 results in step 158 determining that communications can proceed by the direct transmission of character based messages between the user and the selected PSAP as previously described.

A NO decision by step 156 results in step 160 causing a conventional voice path to be established between the origination switch 104 and the identified PSAP 120. The call path is initially established by a request from origination switch 104 by the SS 7 network 114 that results in an allocation of a communication channel through PSTN 112 and termination switch 116 to PSAP 120. The character based message received from the user is converted by step 162 into speech by the text-to-speech facility 111. This converted speech is transmitted by step 164 over the established voice path to PSAP 120. Preferably, a stored announcement at origination switch 104 is played at the beginning of the communication to identify the speech that follows as converted from text to alert the PSAP operator.

Users may not completely spell out each intended word when using a character based message. For example, the user may use the abbreviation “b4” to represent the word “before”, or “IMO” to mean the phrase “in my opinion”. As is known to those that frequently use character based messages, various abbreviations exist and are utilized to minimize the number of characters that must be typed, often on a keypad that is more difficult to use than a standard keyboard. Because a user transmitting an emergency request using a character based message may employ such shortcuts, it is preferred that the text-to-speech facility 111 be able to accommodate such usage by providing the PSAP operator with appropriate voiced information. Preferably, the text-to-speech facility 111 includes a dictionary that can be utilized as a spell checking resource. For characters or groups of characters that are not recognized in the dictionary as valid words, the text-to-speech facility 111 can voice each character separately to provide the PSAP operator the opportunity to discern the intended meaning by the user. The voice representation of certain letters sound similar such as “B, C, and D”. Therefore, it may be desirable for the text-to-speech facility 111 to voice individual letters not as the sound of the letter, but as a known phonetic representation such as Bravo for “B”, Charlie for “C” and Delta for “D”. With the PSAP operator having been alerted that the message which follows has been converted from a text based message, such techniques will give the operator a better opportunity to discern the meaning intended by the user.

In step 164 the speech representation is transmitted over the voice path to the PSAP. In step 166 a determination is made by the operator if there is sufficient information to determine the urgency, agency to be contacted, and location of the user. A YES determination in step 166 results in the operator requesting emergency services at step 168 from the appropriate agency. With emergency services having been summoned by the operator, the process terminates at STOP step 170. A NO determination at step 166 results in the operator transmitting a request to the user seeking additional information at step 172. As explained above, the operator may verbalize a request that will be converted into a character based message by speech recognition software at sound-to-text facility 113. Alternatively, the operator knowing that the user requires a text based message based on the alert, may elect to send a communication to the user by typing on an associated terminal and causing conventional modems signals to be transmitted over the voice channel. Such signals will likely yield greater accuracy in the resulting sound-to-text conversion by facility 113 as opposed to speech recognition, especially considering the distortion and variations that may be present due to traversing the telecommunication system between PSAP 120 and origination switch 104. The sound-to-text facility 113 converts the operator's request into alphanumeric (text) characters at step 174. The origination switch 104 in step 176 transmits a character based message to the user containing the text characters representing the request by the operator. Following step 176, the process returns to the beginning of step 166 where the operator determines whether sufficient information is present after receiving a further reply from the user.

The illustrative structure, systems and methods are presented to teach those in the relevant arts how to make and practice embodiments of the present invention. The illustrative embodiments are exemplary of the present invention and not intended to be inclusive of all variations and modifications that are possible to practice the present invention. For example, structural elements may be connected to different elements in the system while providing the same or similar functionality. Also, some structural elements may be incorporated into other structural elements depending on the specific resources and capacities of the devices available to the designer. For example, a single adjunct may perform the text-to-speech and sound-to-text functions, or both of these functions may be integrated into the origination switch, or may be provided by another facility such as an SCP. Alternatively, a sound-to-text function could be omitted if a communication to the user from the PSAP operator is not to be provided. It will be apparent that a PSAP that happens to be supported by the origination switch of the user will not require communications through the PSTN or a different termination switch. It will also be apparent that where the PSAP can directly receive character based messages, it is possible for the character based message to enter the telecommunication network at a node other than an origination switch if the node is capable of routing the message to an appropriate PSAP. The steps associated with the exemplary methods of the present invention may be combined with other steps or modified while still providing the same or similar functions, and may be implemented by other apparatus.

We claim:

1. A method for transmitting a character based message from a user in a telecommunication system to a public safety answering point comprising the steps of:
receiving an emergency character based message addressed to a predetermined emergency address;
identifying a first public safety answering point to receive the emergency character based message;
determining if the first public safety answering point is capable of receiving the emergency character based message in character based format;
if the first public safety answering point is capable of receiving the emergency character based message in character based format, then transmitting the emergency character based message to the first public safety answering point by substituting a first message address of the first public safety answering point for the predetermined emergency address.

2. The method according to claim 1 wherein the emergency character based message is received that an origination switch and the first public safety answering point is identified from among a plurality of first public safety answering points based on geographic proximity of the user and of help available from the first public safety answering point.

3. The method according to claim 1 wherein the step of determining if the first public safety answering point is capable of receiving the emergency character based message in character based format comprises a query of a database containing a record associated with the first public safety answering point, the record including a field that identifies whether the associated public safety answering point is capable of receiving character based format messages.

4. A method for transmitting a communication derived from a character based message from a user in a telecommunication system to a public safety answering point comprising the steps of:
receiving an emergency character based message addressed to a predetermined emergency address;
identifying a first public safety answering point to respond to the emergency character based message;
translating with a text to speech translator the character based message into voice communications that are transmitted to the first public safety answering point.

5. The method according to claim 4 further comprising the step of translating the predetermined emergency address into a telephone number associated with accessing the first public safety answering point.

6. The method according to claim 4 further comprising the step of determining whether the first public safety answering point is capable of directly receiving a message in character based message format.

7. The method according to claim 4 wherein the step of translating comprises translating alphanumeric characters into corresponding words that are transmitted as voice communications to the first public safety answering point.

8. The method according to claim 4 wherein the step of translating comprises translating each alphanumeric character into a corresponding voice representation that is transmitted to the first public safety answering point.

9. The method according to claim 4 wherein the step of translating comprises identification of words in the character based message that have a known dictionary meaning and translating said words into a voice representation that is transmitted to the first public safety answering point.

10. An apparatus for communicating information contained in a character based message from a user in a telecommunication system to a public safety answering point comprising:
means for receiving a character based message addressed to a predetermined emergency address;
a text to speech translator coupled to the receiving means translates the character based message into voice communications;
means for transmitting the voice communications to the public safety answering point.

11. The apparatus according to claim 10 further comprising means for translating the predetermined emergency address into a telephone number associated with accessing the public safety answering point.

12. The apparatus according to claim 10 wherein the translator translating alphanumeric characters into corresponding words that are transmitted as voice communications to the public safety answering point.

13. The apparatus according to claim 10 wherein the translator translates each alphanumeric character into a corresponding voice representation that is transmitted to the public safety answering point.

14. The apparatus according to claim 10 wherein the translator identifies words in the character based message that have a known dictionary meaning and translates said words into a voice representation that is transmitted to the public safety answering point.

15. The apparatus according to claim 14 wherein the translator identifies characters in the character based message that do not having a known dictionary meaning and translates each of said characters into a voice representation that is transmitted to the public safety answering point.
